(19) United States
(12) Patent Application Publication
(10) Pub. No.: US 2025/0062951 A1
(43) Pub. Date: Feb. 20, 2025

(54) UNSUPERVISED MULTI-MODAL CAUSAL STRUCTURE LEARNING FOR ROOT CAUSE ANALYSIS

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Lecheng Zheng, Monmouth Junction, NJ (US)

(21) Appl. No.: 18/801,922

(22) Filed: Aug. 13, 2024

Related U.S. Application Data
(60) Provisional application No. 63/533,395, filed on Aug. 18, 2023.
(60) Provisional application No. 63/542,424, filed on Oct. 4, 2023.

(51) Int. Cl. H04L 41/0659; H04L 41/0631; H04L 41/0816

(52) U.S. Cl. CPC H04L 41/0661; H04L 41/0631; H04L 41/0816

(57) ABSTRACT

Systems and methods for unsupervised multi-modal causal structure learning for root cause analysis. System logs of a cloud system can be transformed to time-series data using a log-tailored language model to obtain system log features of the cloud system. A metric causal graph and a log causal graph can be predicted from modality-specific representations and modality-invariant representations of extracted system metric features and system log features, respectively, using the deep neural network. The metric causal graph and log causal graph can be fused to obtain a fused causal graph. Root causes of system failure can be flagged for system maintenance based on ranked entities obtained from the fused causal graph to obtain flagged root causes. System maintenance can be performed autonomously based on the flagged root causes from identified system entities to optimize the cloud system with an updated configuration.

### RELATED APPLICATION INFORMATION

This application claims priority to U.S. Provisional App. No. 63/533,395, filed on Aug. 18, 2023, and U.S. Provisional App. No. 63/542,424, filed on Oct. 4, 2023, incorporated herein by reference in its entirety.

### BACKGROUND

### Technical Field

The present invention relates to artificial intelligence for information technology operations (AIOps) for distributed computing environments, and more particularly to unsupervised multi-modal causal structure learning for root cause analysis.

### Description of the Related Art

Current cloud systems interconnect numerous computing nodes to provide robust, scalable, online workflow processes. Because of the large number of computing nodes and processes generated, current cloud systems produce enormous amounts of data. Such data could be used to determine the status of a cloud system concerning a system failure. However, finding a vulnerability within the cloud system using such data to determine the root cause of a system failure would be a difficult task. Additionally, due to the immense scale of cloud systems, a significant amount of time and resources would be allotted to identify, solve, and prevent such issues.

### SUMMARY

According to an aspect of the present invention, a computer-implemented method for unsupervised multi-modal causal structure learning for root cause analysis is provided including transforming, using a log-tailored language model, system logs of a cloud system to time-series data to obtain system log features of the cloud system, predicting, using a deep neural network, a metric causal graph and a log causal graph from modality-specific representations and modality-invariant representations of extracted system metric features and system log features, respectively, of the cloud system, fusing the metric causal graph and log causal graph to obtain a fused causal graph, flagging root causes of system failure for system maintenance based on ranked entities obtained from the fused causal graph to obtain flagged root causes, and performing system maintenance autonomously based on the flagged root causes from identified system entities to optimize the cloud system with an updated configuration.

According to another aspect of the present invention, a system for unsupervised multi-modal causal structure learning for root cause analysis is provided, including a memory device, and one or more processor devices operatively coupled with the memory device to transform, using a log-tailored language model, system logs of a cloud system to time-series data to obtain system log features of the cloud system, predict, using a deep neural network, a metric causal graph and a log causal graph from modality-specific representations and modality-invariant representations of extracted system metric features and system log features, respectively, of the cloud system, fuse the metric causal graph and log causal graph to obtain a fused causal graph, flag root causes of system failure for system maintenance based on ranked entities obtained from the fused causal graph to obtain flagged root causes, and perform system maintenance autonomously based on the flagged root causes from identified system entities to optimize the cloud system with an updated configuration.

According to another aspect of the present invention, a non-transitory computer program product is provided including a computer-readable storage medium having program code for unsupervised multi-modal causal structure learning for root cause analysis, wherein the program code when executed on a computer causes the computer to transform, using a log-tailored language model, system logs of a cloud system to time-series data to obtain system log features of the cloud system, predict, using a deep neural network, a metric causal graph and a log causal graph from modality-specific representations and modality-invariant representations of extracted system metric features and system log features, respectively, of the cloud system, fuse the metric causal graph and log causal graph to obtain a fused causal graph, flag root causes of system failure for system maintenance based on ranked entities obtained from the fused causal graph to obtain flagged root causes, and perform system maintenance autonomously based on the flagged root causes from identified system entities to optimize the cloud system with an updated configuration.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for unsupervised multi-modal causal structure learning for root cause analysis, in accordance with an embodiment of the present invention;

FIG. 2 is a block diagram illustrating a system for unsupervised multi-modal causal structure learning for root cause analysis, in accordance with an embodiment of the present invention;

FIG. 3 is a block diagram showing a cloud intelligent system architecture for unsupervised multi-modal causal structure learning for root cause analysis, in accordance with an embodiment of the present invention;

FIG. 4 is a block diagram illustrating a cloud system having cloud computing nodes that cloud consumers communicate with, in accordance with an embodiment of the present invention;

FIG. 5 is a block diagram illustrating a practical application of unsupervised multi-modal causal structure learning for root cause analysis for artificial intelligence operations of a cloud system, in accordance with an embodiment of the present invention; and

FIG. 6 is a block diagram illustrating deep learning neural networks for unsupervised multi-modal causal structure learning for root cause analysis for artificial intelligence operations of a cloud system, in accordance with an embodiment of the present invention.

### DETAILED DESCRIPTION OF PREFERRED EMBODIMENTS

In accordance with embodiments of the present invention, systems and methods are provided for unsupervised multi-modal causal structure learning for root cause analysis.

In an embodiment, a cloud system can be optimized autonomously through system maintenance based on flagged root causes of system failure. Root causes of system failure can be flagged for system maintenance based on ranked entities obtained from a fused causal graph to obtain flagged root causes. A fused causal graph can be obtained by fusing a metric causal graph and log causal graph. The metric causal graph can be predicted using a deep neural network from metric-specific representations and metric-invariant representations of extracted system metric features of the cloud system. The log causal graph can be predicted using the deep neural network from metric-specific representations and metric-invariant representations of system log features. System log features of the cloud system can be obtained by transforming system logs of a cloud system to time-series data using a log-tailored language model.

In another embodiment, a system maintenance plan can be created based on the flagged root causes that can assist the decision making of a cloud system professional by generating recommendations to fix issues and vulnerabilities caused by the flagged root causes.

The rise of internet applications has sparked substantial interest in the concept of microservices as a cloud-native architectural strategy. This attention is particularly prominent for applications that require support across diverse platforms, such as 5G networks, the web, and the Internet of Things (IoT). The performance quality of microservices is important to cloud platforms, as any system fault within a microservice can lead to a decline in user experience and result in significant financial losses. Nevertheless, system failures are an inevitable facet of complex systems. Potential triggers for these events include service level deterioration and inconspicuous breakdowns, including reduced throughput and increased response times and error rates.

Due to the extensive array of microservice system components and complex dependency connections involved, other methods are time-consuming, labor-intensive, and error prone. Consequently, an efficient and effective root cause analysis for failure diagnosis has become increasingly important for microservices. Such analysis would facilitate swift service recovery and adept loss mitigation. Additionally, during system failures, information systems can generate various data types, including system metrics, logs, events, and alerts. Effectively extracting and leveraging this information for pinpointing root causes can pose a significant challenge due to the complexity and overwhelming size of the information.

The present embodiments can address the aforementioned issues regarding identifying the root causes of failure or fault events, particularly when various data is present in cloud systems. Specifically, by collecting and processing comprehensive data from the cloud system, a precise and effective method for detecting the system entities that are most likely to be the root cause of the failure or fault incidents can be achieved by the present embodiments. Thus, the present embodiments can improve the reliability and performance of a cloud system by performing autonomous system maintenance that aid in diagnosing and solving failures or faults in cloud and microservice systems which is a fundamental challenge with Artificial Intelligence for Information Technology Operations (AIOps).

Additionally, the present embodiments improve artificial intelligence models used for AIOps (AIOps Models) as the present embodiments can detect root causes more accurately than other AIOps Models due to multi-modal nature of causal learning employed by the present embodiments.

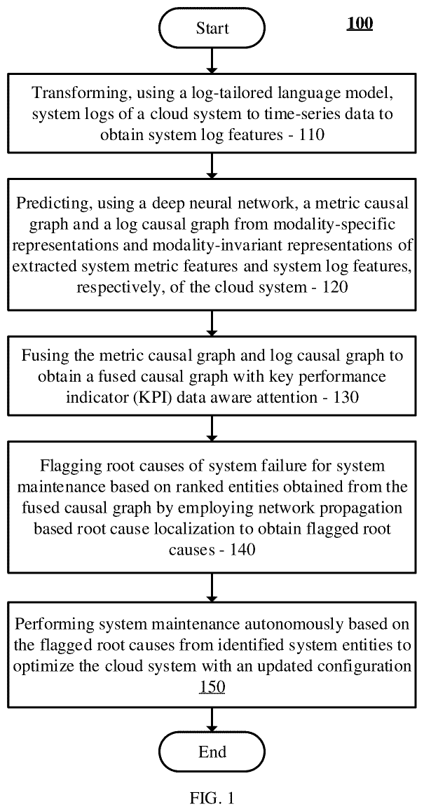

Referring now in detail to the figures in which like numerals represent the same or similar elements and initially to FIG. 1, a high-level overview of a method for unsupervised multi-modal causal structure learning for root cause analysis is illustratively depicted in accordance with one embodiment of the present invention.

In an embodiment, the computer-implemented method for unsupervised multi-modal causal structure learning for root cause analysis can autonomously perform system maintenance based on flagged root causes from identified system entities to optimize the cloud system with an updated configuration. Root causes of system failure can be flagged for system maintenance based on ranked entities obtained from a fused causal graph to obtain flagged root causes. A fused causal graph can be obtained by fusing a metric causal graph and log causal graph. A metric causal graph can be predicted using a deep neural network from modality-specific representations and modality-invariant representations of extracted system metric features of the cloud system. A log causal graph can be predicted using the deep neural network from modality-specific representations and modality-invariant representations of system log features. System log features of the cloud system can be obtained by transforming system logs of a cloud system to time-series data using a log-tailored language model.

In block 110, system logs of a cloud system can be transformed to time-series data using a log-tailored language model to obtain system log features.

In an embodiment, collected data from the system entities of a cloud system can be transformed into time-series data using a log-tailored language model. The system entities can be a physical machine, container, virtual machine, pod, etc. The collected data can include three types: system logs, system metrics, and key performance indicator (KPI) data.

KPI data 312 can contain system performance information (e.g. features) such as elapsed time, latency, connect time, thread name, throughput etc. A load testing tool can be employed to collect KPI data. The load testing tool can be JMeter®, Locust®, etc. Other load testing tools are contemplated. The KPI data 312 can be formatted in a chronological order having the data related to time to be included in the beginning. For example, the format can be “timestamp, elapsed, idle time, connect time, etc.”

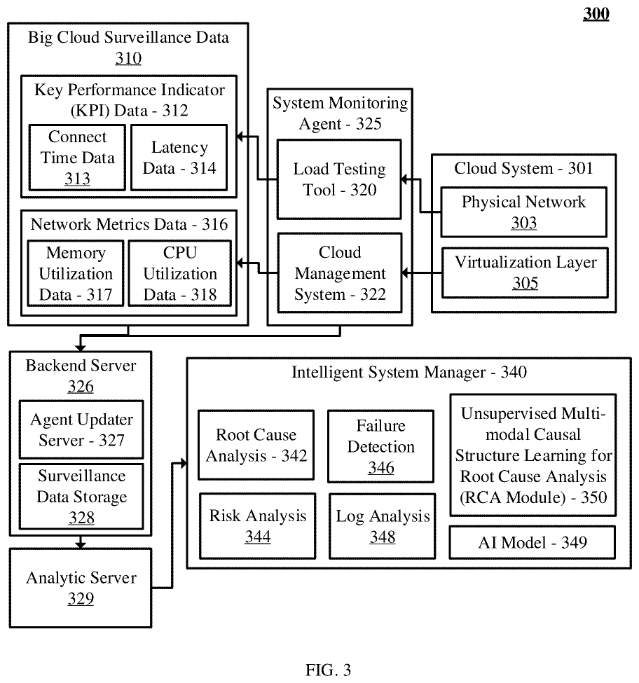

The latency data 314 (shown in FIG. 3) and connect time data 313 (shown in FIG. 3) can be the primary performance KPIs of the whole cloud system. The latency data 314 can measure the latency from just before sending the request from a system entity, to just after a first chunk of the response has been received by another system entity. Connect time data 313 can measure the time it took to establish the connection between at least two system entities, including a secure sockets layer (SSL) handshake. Both latency data 314 and connect time data 313 can be time series data, which can indicate the system status and can directly reflect the quality of service. The quality of service can show whether the whole system has some failures events happening or not because a system failure can result when the latency data 314 or connect time data 313 is significantly increasing than normal.

The cloud management system 322 (shown in FIG. 3) can collect network metrics data 316. The cloud management system 322 can be OpenShift®, Prometheus™, etc. Other cloud management systems are contemplated. The network metrics data 316 can contain a number of metrics which indicate the status of a cloud system's underlying component or entity. The underlying component or entity can be a cloud system's underlying physical machine, container, virtual machine, or pod. The system entities can include tasks and workloads such as a database management system, dispatch system, etc. The network metrics data 316 (e.g. features) can be the CPU utilization or saturation data 318 (shown in FIG. 3), memory utilization or saturation 317 (shown in FIG. 3), or disk IO utilization. An anomalous component metric of a cloud system's underlying component can be the potential root cause of an anomalous latency data 314 or connect time data 313, which can indicate a cloud system failure.

The system logs can contain the records of the cloud system events that can indicate how the cloud system processes and drivers were loaded, etc. The system logs data can be unstructured data (e.g., prose or plain text) in its unprocessed form.

In an embodiment, the system logs can be transformed into time-series data to formulate an objective function for training a log-tailored language model by processing the system logs to obtain structured log templates. Existing log parsers (e.g., Drain Parser, etc.) can be utilized to get structured log templates. The system logs can be partitioned into multiple time windows with fixed sizes. For each time window, a log sequence can be obtained. The log sequences can include unique log templates that occur within a specific time range. The log templates can be treated as tokens and can be organized based on their order of appearance from the system logs. The frequency of a log template can be monitored and leveraged for an objective function to train a large language model and obtain a log-tailored language model.

The language model for predicting the anomaly score can be log-based anomaly detection models such as multi-scale one-class recurrent neural network for detecting anomalies (OC4Seq) or anomaly detection and diagnosis from system logs through deep learning (Deep log). Other log-based anomaly detection models are contemplated.

In an embodiment, the log-tailored language model can be trained by optimizing the objective function. The trained log-tailored language model can be employed to generate a log representation. The log representation can include the system log features. The log-tailored language model can be a regression-based language model.

In block 120, a metric causal graph and a log causal graph can be predicted using a deep neural network from modality-specific representations and modality-invariant representations of extracted system metric features and system log features, respectively, of the cloud system.

In an embodiment, the extracted system data metrics can be transformed to modality-specific representations and modality invariant representations. The modality-specific representations and modality-invariant representations of the system data metrics can be employed to predict a metric causal graph using a deep neural network.

The modality-specific representations can represent the features that only relate to one modality. Conversely, modality-invariant representations can represent features that can be affected by more than one modality. For example, a modality-specific representation can include a system metric data feature that is not included in a log template, and a modality-invariant representation can include a system metric data feature that is included in a log template (e.g., disk utilization, CPU utilization, etc.).

The system metrics data can be represented as a multi-variate time series data X^{M} and the i-th metric data, where i is an element of the total number of entities in the cloud system:

$${X}^{M} = {X}_{i , 0}^{M} , … {X}_{i , T}^{M} ∈ {ℝ}^{( n - 1 ) \times T} ,$$

where T is a given time within a sliding window of time interval, n is the number of entities, plus system KPI data, in the cloud system, [symbol] is a set of real numbers. KPI data can be concatenated to X^{M}.

The system log features can be represented as a multi-variate time series data X^{L} and the i-th metric data, where i is an element of the total number of entities in the cloud system,

$${X}^{L} = {X}_{i , 0}^{L} , … {X}_{i , T}^{L} ∈ {ℝ}^{( n - 1 ) \times T} ,$$

where T is a given time within a sliding window of time interval, n is the number of entities plus system KPI data in the cloud system, [symbol] is a set of real numbers. KPI data can be concatenated to X^{L}.

The modality-invariant representation for the system metric data and system log data (Rₘᵢ^{v}) can be:

$${R}_{m i}^{v} = {E}_{m i}^{v} ( {X}^{v} , {A}^{v} ) ∈ {ℝ}^{n \times m \times d 1}$$

where v includes L for system logs and M for system metrics, A^{v} is an adjacency matrix that is learnable by the deep neural network to capture the non-linear relationships among system entities, n is the number of system entities plus system KPI data, m is the length of effective timestamps, d1 is a hidden feature dimension, [symbol] is a set of real numbers, Eₘᵢ^{v}( ) is an output of an encoder. The encoder can be a graph neural network such as an inductive representation learning on large graphs (GraphSage). Other graph neural networks are contemplated.

The modality-specific representation for the system metric data and system log data (Rₘₛ^{v}) can be:

$${R}_{m s}^{v} = {E}_{m s}^{v} ( {X}^{v} , {A}^{v} ) ∈ {ℝ}^{n \times m \times d 1}$$

where v includes L for system logs and M for system metrics, AU is an adjacency matrix that can be learned by the deep neural network to capture the non-linear relationships among system entities, n is the number of system entities plus system KPI data, m is the length of effective timestamps, d1 is a hidden feature dimension, [symbol] is a set of real numbers, Eₘₛ^{v}( ) is an output of an encoder. The encoder can be GraphSage.

In an embodiment, to ensure that there is no overlap between the modality-invariant and modality-specific representations we can leverage an orthogonal constraint (Lₒᵣₜₕ):

$${L}_{orth} = {\sum }_{i = 1}^{n} {‖ {( {R}_{m s , i}^{v} )}^{T} {R}_{m i , i}^{v} ‖}_{F}^{2}$$

where v includes L for system logs and M for system metrics, n is the number of system entities plus system KPI data, R_{ms,i}^{M} is the i-th modality-specific representation, R_{mi,i}^{M} is the i-th modality-invariant representation, where i an element of n, and F is the Frobenius norm.

The deep neural network can be a graph neural network such as an inductive representation learning on large graphs (GraphSage) and can be employed as an encoder. Other graph neural networks are contemplated.

The deep neural network can predict the adjacency matrix of the metric causal graph based on the representation of edges (Ledge):

$${L}_{edge} = {\sum }_{i , j} {‖ G ( {e}_{i , j}^{v} ) - {A}_{i , j}^{v} ‖}^{2}$$

where v includes L for system logs and M for system metrics, e_{i,j}^{v}=[MLP(R_{mi,i}^{v}), MLP(R_{mi,j}^{v})] which is a concatenation of the representation of two entities i and j, where MLP( ) is a multi-layer perceptron (MLP) that can be used to map the representation Rₘᵢ^{M} to another latent space, G( ) is a one-layer MLP followed by the sigmoid activation function used to predict an existence of an edge in A^{M}. The MLP models can be implemented with TensorFlow™, PyTorch™, etc.

The metric causal graph can include both system entities and the KPI data. In an embodiment, the topological structure of metric causal graph can be encoded to capture the relationship between the root causes and the KPI data.

In an embodiment, before predicting the respective future values of the log causal graph and the metric causal graph using a decoder, the mutual information between the two representations can be maximized using contrastive learning regularization to ensure mutual information agreement between the modality-invariant representations of both metric and log data:

$${L}_{node} = - \frac{1}{n} {\sum }_{i = 1}^{n} log \frac{s i m ( M L P [ {R}_{m i}^{M} ] , MLP [ {R}_{m i}^{L} ] )}{{Σ}_{k} s i m ( M L P [ {R}_{m i}^{M} ] , M L P [ {R}_{m i}^{L} ] )}$$

$$where sim ( {a}_{i} b ) = exp ( \frac{a {b}^{T}}{\vert a \vert \vert b \vert} ) ,$$

a includes MLP[Rₘᵢ^{M}], b includes MLP[Rₘᵢ^{L}] and MLP[Rₘᵢ^{L}], i and k are elements of the system entities, MLP( ) is a MLP that can be used to map the representation to another latent space.

After extracting both modality-invariant and modality-specific representations, a future value X^{fv} with the previous time-lagged data can be predicted with a vector autoregression (VAR) model:

$${L}_{var} = {‖ {X}^{fv} - D ( {R}_{m s ,}^{v} + {R}_{m i}^{v} ) ‖}^{2}$$

where v includes L for system logs and M for system metrics, D( ) is a deep neural network decoder.

In block 130, the log causal graph and metric causal graph can be fused to obtain a fused causal graph.

In an embodiment, the log causal graph G and the metric causal graph can be combined with KPI-aware attention-based causal graph fusion by measuring a cross correlation of raw feature of each entity for each modality and the KPI data to alleviate the potential negative impact of low-quality modalities:

$${S}^{v} = {max}_{τ ∈ [ 0 , T ]} ( {X}^{v} * Y ) ( τ ) = max {\int }_{t = 0}^{+ ∞} {X}^{v} ( t + τ ) \cdot Y ( t ) dt$$

where v∈{M, L} denotes two types of modalities system logs (L) and system metrics (M), τ is the time lag, t is a given time, and T is the max time lag. S^{v} can measure the similarity between each entity and KPI Y with τ time-lag. A large value of S^{v} can indicate a stronger causal relation between entity and KPI.

By assuming that the temporal pattern of the top k (topk) entity of high-quality modality is highly likely to be similar to the temporal pattern of KPI, we utilize S^{v}, v∈{M, L} denotes two types of modalities, to measure the quality of each modality as follows:

$$i d {x}^{v} = topk ( {S}^{v} [ - 1 , : ] ; k )$$

$${Score}^{v} = {softmax}_{v ∈ \{ M , L \}} ( {\sum }_{i ∈ {idx}^{v}} {S}^{v} [ i ] )$$

In an embodiment, the final fused adjacency matrix can be obtained by leveraging the modality importance score Score^{v} to model the temporal dependency of each modality:

$${R}^{L} = {R}_{C} + {R}_{s}^{L} , {R}^{M} = {R}_{C} + {R}_{s}^{M}$$

$$A = {score}^{L} * {A}^{L} + {score}^{M} * {A}^{M}$$

where A is the final adjacency matrix by reweighting the importance of each modality, A^{L} is the learned adjacency matrix for the system log, A^{M} is the learned adjacency matrix for the system metrics, score^{L} is the modality importance score for the system log, score^{M} is the modality importance score for the system metrics.

The overall objective function could be formulated below:

$$ℒ = {\sum }_{v} ( {α}_{1} {L}_{v a r}^{v} + {α}_{2} {L}_{orth}^{v} + {α}_{3} {L}_{e d g e}^{v} + {α}_{4} {‖ {Score}^{v} ‖}_{1} ) + {L}_{n o d e} + λ h ( A )$$

where v∈{M, L} denotes two types of modalities, α₁, α₂, α₃ α₄ and λ are constant hyper-parameters, and A is the final adjacency matrix, Score^{v} is the modality importance score, Lᵥₐᵣ^{v} is the objective function used to predict future value X^{fv} with the previous time-lagged data can be predicted with a vector autoregression (VAR) model, L_{node} is the objective function used to maximize the log causal graph and metric causal graph, Ledge is the objective function used to predict the adjacency matrix of the metric causal graph based on the representation of edges, Lₒᵣₜₕ^{v} is the objective function used to ensure no overlap between modality-invariant and modality-specific representations.

In block 140, root causes of system failure can be flagged for system maintenance based on ranked entities obtained from the fused causal graph to obtain flagged root causes.

In an embodiment, to pinpoint the root cause for system failure, a transition probability matrix can be derived from the fused causal graph to determine entities that will be ranked based on their probability scores. The transition probability matrix can be derived from the fused causal graph with:

$${P}_{i , j} = \frac{( 1 - β ) {A}_{j , i}}{{\sum }_{k = 1}^{n} {A}_{k , i}}$$

where A is the adjacency matrix with i and j as nodes of the fused causal graph representing system entities, n is the number of system entities plus system KPI data, β∈[0, 1] can represent the probability of transitioning from one node to another.

To emulate propagation patterns of malfunctions, a probability transition equation for a random walk can be formulated

$${P}_{t + 1} = ( 1 - c ) {P}_{t} + c {P}_{0}$$

where Pₜ denotes the jumping probability at the t-th step, P₀ is the initial starting probability and c∈[0, 1] is the restart probability.

After Pₜ converges, the probability scores of the nodes can be used to rank the system entities to obtain ranked entities. The top k entities can then be selected as the likely root causes for system failure. The root causes for system failure can then be flagged for system maintenance by adding the root causes to a system maintenance list as flagged root causes. For example, during a system failure, computing node 1 produced system logs containing a significant increase in CPU utilization and latency; computing node 2 produced system logs containing normal parameters. The present embodiments can autonomously perform system maintenance on computing node 1 which is likely to be selected as the root cause for the system failure.

In block 150, system maintenance can be autonomously based on the flagged root causes from identified system entities to optimize the cloud system with an updated configuration.

The present embodiments can improve the cloud system by autonomously performing system maintenance based on a system maintenance plan that can be tailored to the detected change point to optimize the cloud system with an updated configuration. For example, if the flagged root cause is related to disk utilization and external storage, the system maintenance plan can include updating the cloud system with additional disk storage resources, updating the virtualization layer of the cloud system, blocking packets from a specific internet protocol (IP) address, etc.

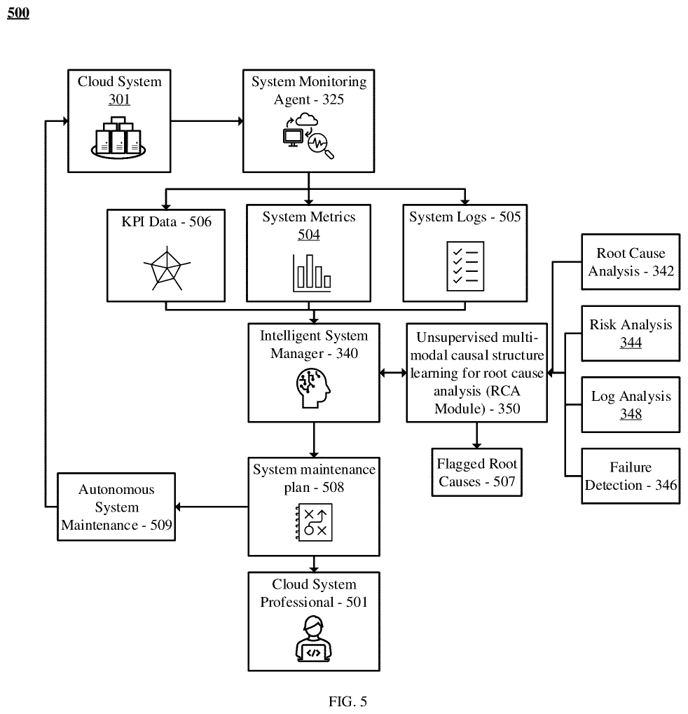

In an embodiment, an intelligent system manager 340 (shown in FIG. 3) can process the flagged root causes and create a system maintenance plan 508 (shown in FIG. 5) for the cloud system 301 to resolve a system issue caused by the flagged root causes. The system maintenance plan 508 can include applying system patches to the cloud system 301 to overcome a system vulnerability that can be caused by the flagged root causes. The system monitoring agent 340 can then autonomously place the cloud system 301 under system maintenance to install the system patches. The installation of the system patches can be done in the background without interfering with access to the cloud system 301.

In another embodiment, the system maintenance plan 508 can include updating the system configuration of the physical network 303 of the cloud system 301 such as increasing CPU or memory capacity. In another embodiment, the system maintenance plan 508 can include updating the configuration of the virtualization layer 305 of the cloud system 301 such as updating container and node configuration.

In another embodiment, the intelligent system manager 340 can notify a cloud system professional 501 through an alarm module regarding the results of the root cause analysis based on the flagged root causes.

In another embodiment, the intelligent system manager 340 can output explanations regarding system faults or failure based on the flagged root causes. The flagged root causes can have identifiable sources and timestamps on which point and batch of processing the change point and detected root cause for system failure occurred (e.g., batch processing data). The source identifier, timestamp, batch processing data can be compiled and converted to a complete sentence to produce an explanation of how a system fault or failure occurred due to the detected root cause for system failure. In another embodiment, the conversion to complete sentences can be done by an artificial intelligence model 349.

In another embodiment, the intelligent system manager 340 can perform log analysis and process the logs produced in the cloud system and detect root causes for system failures within the cloud system through the logs. The intelligent system manager 340 can generate alerts regarding system failures identified in the logs. Once a log has been identified that was related to the predicted root cause for system failure, the intelligent system manager 340 can autonomously perform a system maintenance to avoid a potential system failure from the log.

In another embodiment, the intelligent system manager 340 can perform risk analysis by analyzing the flagged root causes to identify the potential issues and consequences associated with the flagged root causes. The identified potential issues can be assessed to evaluate their severity and likelihood of occurrence. The identified potential issues can be ranked based on severity and likelihood of occurrence which can be presented to the cloud system professional to help with their decision making.

The present embodiments can employ unsupervised multi-modal causal structure learning for root cause analysis methods and systems for AIOps in a cloud system that can overcome the difficulty of handling big data for the cloud system in determining root causes for system vulnerabilities and system failures of the cloud system in an effective and timely manner, thus, improving cloud systems. The present embodiments can effectively identify the root causes for system failure by leveraging multiple modalities (e.g., system metrics, KPI data, system logs). The present embodiments can timely identify the root causes in a matter of seconds by employing a deep neural network. The present embodiments can predict future root causes as the deep neural network can learn the most likely root causes of system failure and can thus, predict system fixes for the predicted root causes of system failure.

Additionally, the present embodiments improve artificial intelligence models used for AIOps (AIOps Models) as the present embodiments can detect root causes more accurately than other AIOps Models due to the multi-modal nature of causal learning employed by the present embodiments.

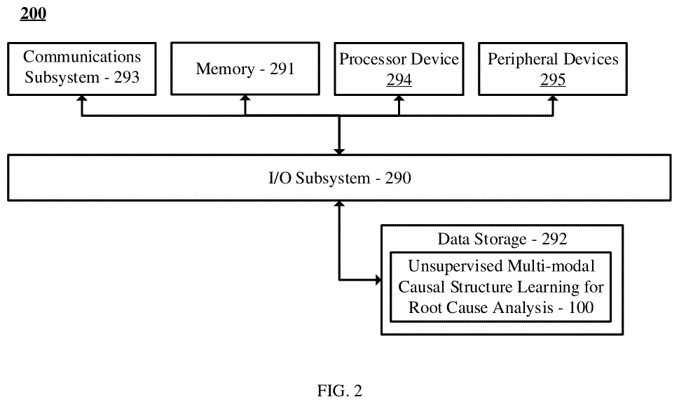

Referring now to FIG. 2, a block diagram showing a system for unsupervised multi-modal causal structure learning for root cause analysis 200, in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for unsupervised multi-modal causal structure learning for root cause analysis 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

The cloud system can have at least the following characteristics: on-demand self-service, broad network access, resource pooling, rapid elasticity, and measured service.

The cloud system can have at least the following Service Models: Software as a Service (SaaS), Platform as a Service (PaaS), and Infrastructure as a Service (IaaS).

The cloud system can have at least the following Deployment Models: private cloud, community cloud, public cloud, or hybrid cloud.

Referring now to FIG. 3, a block diagram showing a cloud intelligent system architecture for unsupervised multi-modal causal structure learning for root cause analysis, in accordance with an embodiment of the present invention.

The cloud intelligent system architecture 300 can have several components, layers, and functions.

The physical network 303 can include hardware and software components. Examples of hardware components include: mainframes, RISC (Reduced Instruction Set Computer) architecture-based servers, servers, blade servers, storage devices, and networks and networking components. In some embodiments, software components include network application server software and database software.

The virtualization layer 305 provides an abstraction layer from which the following examples of virtual entities may be provided: virtual servers, virtual storage, virtual networks, including virtual private networks, virtual applications, operating systems, and virtual clients.

In an example, the management layer may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer provides examples of functionality for which the cloud computing environment may be utilized. Examples of workloads and functions which may be provided from this layer include software development and lifecycle management, data analytics processing, and transaction processing.

In an embodiment, the data analytics processing in workloads layer can include the system monitoring agent 325, backend server 326, analytics server 329 and the intelligent system manager 340.

In an embodiment, the cloud system 301, backend server 326, and analytics server 329 can be positioned in geographically different locations and interconnected by networks. In another embodiment, the cloud system 301, backend server 326, and analytics server 329 can be positioned in the same geographical location and interconnected by networks.

The backend server 326 and analytics server 326 can include hardware and software components. Examples of hardware components include: mainframes, RISC architecture based servers, servers, blade servers, storage devices, and networks and networking components. In some embodiments, software components include network application server software and database software.

In an embodiment, the intelligent system manager 340 can include root cause analysis module 342, a risk analysis module 344, a failure detection module 346, and a log analysis module 348. The intelligent system manager 340 can include unsupervised multi-modal causal structure learning for root cause analysis 100.

The root cause analysis module 342 can perform the root cause analysis for the cloud system described herein. The risk analysis module 344 can perform the risk analysis for the cloud system described herein. The failure detection module 346 can perform the failure detection for the cloud system described herein. The log analysis module 348 can perform the log analysis for the cloud system described herein.

The intelligent system manager 340 can include an AI model 349 to learn the flagged root causes and predict the system vulnerabilities or issues that may be caused by the flagged root causes. The intelligent system manager 340 can employ the AI model 349 to also predict appropriate fixes to the predicted system vulnerabilities and issues that may be caused by the flagged root causes. The AI Model 349 can be autoencoders, gaussian mixture models, graph neural networks, Bayesian networks, etc. Other artificial intelligence frameworks are contemplated.

The intelligent system manager 340 can be included in an analytic server 329.

The backend server 326 can include an agent updater server 327 and the surveillance data storage 328. The agent updater server 327 can ensure that the system monitoring agent 325 is updated with the latest version of firmware and software updates that are compatible with the current cloud system 301 infrastructure. The backend server 329 can perform data pre-processing of the big cloud surveillance data 310 that has been stored in surveillance data storage 328 within the backend server 326. The data pre-processing process can ensure that the big cloud surveillance data 310 is clean, consistent, and relevant. As such, the data pre-processing process can include data formatting, data quality assurance, data normalization, data integration, data cleaning, etc.

The system monitoring agent 325 can monitor the cloud system 301 by installing a load testing tool 320 and a cloud management system 322. The load testing tool 320 can collect the KPI Data 312 that can include connect time data 313 and latency data 314. The cloud management system 322 can collect network metrics data 316 that can contain a number of metrics which indicates the status of a cloud system's underlying component/entity such as memory utilization data 317 and CPU utilization data 318.

The present embodiments can improve the reliability and performance of a cloud system by performing autonomous system maintenance that aid in diagnosing and solving failures or faults in cloud and microservice systems which is a fundamental challenge with Artificial Intelligence for Information Technology Operations (AIOps).

Additionally, the present embodiments improve artificial intelligence models used for AIOps (AIOps Models) as the present embodiments can detect root causes more accurately than other AIOps Models due to multi-modal nature of causal learning employed by the present embodiments.

A cloud computing environment is service oriented with a focus on statelessness, low coupling, modularity, and semantic interoperability. At the heart of cloud computing is an infrastructure that includes a network of interconnected nodes.

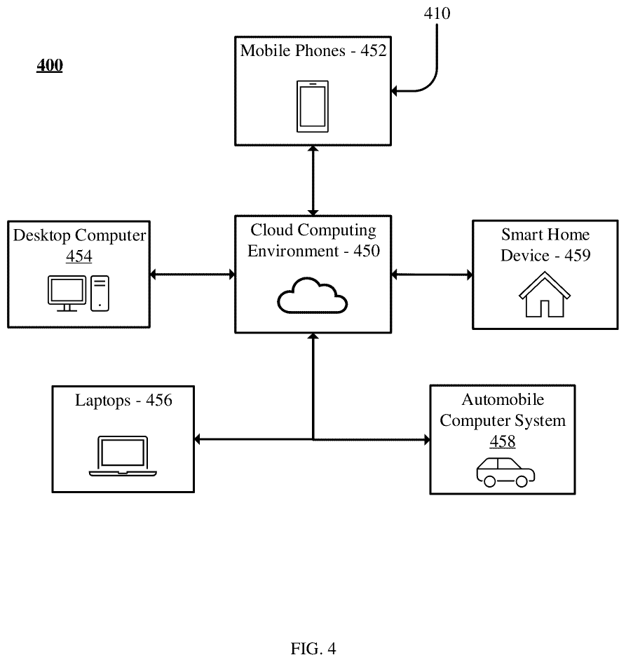

Referring now to FIG. 4, a block diagram illustrating a cloud system having cloud computing nodes that cloud consumers communicate with, in accordance with an embodiment of the present invention.

As shown, cloud system 400 can include a cloud computing environment 450 includes one or more cloud computing nodes 410 with which local computing devices used by cloud consumers, such as, for example, mobile phones 452, desktop computer 454, laptop computer 456, automobile computer system 458, and/or smart home device 459 may communicate. Nodes 410 may communicate with one another. They may be grouped (not shown) physically or virtually, in one or more networks, such as Private, Community, Public, or Hybrid clouds as described herein, or a combination thereof. This allows cloud computing environment 450 to offer infrastructure, platforms and/or software as services for which a cloud consumer does not need to maintain resources on a local computing device. It is understood that the types of computing devices 452, 454, 456, 458, 459 shown in FIG. 4 are intended to be illustrative only and that computing nodes 410 and cloud computing environment 450 can communicate with any type of computerized device over any type of network and/or network addressable connection (e.g., using a web browser).

In an embodiment, the CPD Module 350 of the intelligent system manager 340 can autonomously flag root causes from the interactions between the computing nodes 410 and cloud system 301. Based on the flagged root causes, the system configuration of the cloud system 301 can be updated. For example, for processes concerning mobile phones 452, an anomalous latency data 314 can be identified as a root cause for system failure. A corresponding system maintenance plan 508 can be generated by the intelligent system manager 340 to resolve such issues caused by the root cause for system failure such as increasing bandwidth capacity of the cloud system 301 for mobile phones 452.

Referring now to FIG. 5, a block diagram illustrating a practical application of unsupervised multi-modal causal structure learning for root cause analysis for artificial intelligence operations of a cloud system, in accordance with an embodiment of the present invention.

In an embodiment, cloud system 500 can include an intelligent system manager 502 that can process the flagged root causes 507 and can create a system maintenance plan 508 for the cloud system 301 to resolve a system issue caused by the flagged root causes 507 based on the multiple modalities, system metrics 504, system logs 505, and KPI data 506, that can be extracted by a system monitoring agent 325. The system maintenance plan 508 can include an autonomous system maintenance 509 that can apply system patches autonomously to the cloud system 301 to overcome a system vulnerability that can be caused by the flagged root causes 507. The system patch can be updating hardware or software configuration in accordance with the flagged root causes 507 such as adding more CPU resources, increasing bandwidth, etc.

The intelligent system manager 502 can then provide recommendations to the cloud professional 501 regarding the system maintenance plan 508 to assist with the decision-making of the cloud professional 501. The recommendation can be adding computing resources to a computing node where the root cause for system failure was detected. The recommendation can also be applying system patches to the cloud system 301. The recommendation can also be that the intelligent system manager 502 can autonomously place the cloud system 301 under system maintenance to install the system patches. The installation of the system patches can be done in the background and without interfering with accessing the cloud system 301.

In another embodiment, the intelligent system manager 502 can output explanations regarding system faults or failure based on the flagged root causes as described herein.

In another embodiment, the intelligent system manager 502 can perform log analysis and process the logs produced in the cloud system 301 to perform system maintenance based on the detected root causes for system failures within the cloud system 301 through the logs.

In another embodiment, the intelligent system manager 502 can perform risk analysis by analyzing the flagged root causes for system failure to identify the potential issues and consequences associated with the flagged root causes as described herein.

Other practical applications are contemplated.

The present embodiments can improve the reliability and performance of a cloud system by performing autonomous system maintenance that aid in diagnosing and solving failures or faults in cloud and microservice systems which is a fundamental challenge with Artificial Intelligence for Information Technology Operations (AIOps).

Additionally, the present embodiments improve artificial intelligence models used for AIOps (AIOps Models) as the present embodiments can detect root causes more accurately than other AIOps Models due to multi-modal nature of causal learning employed by the present embodiments.

The present embodiments can employ a deep learning neural network for the intelligent system manager 502 to learn how the root causes for system failures occur and predict potential solutions for the issues and vulnerabilities that the root causes for system failures can cause.

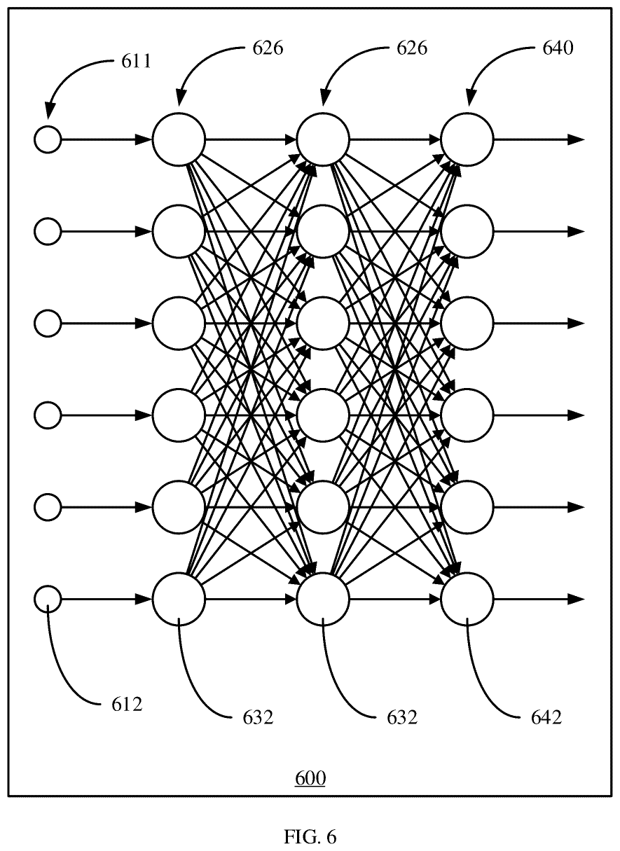

Referring now to FIG. 6, a block diagram illustrating deep learning neural networks for unsupervised multi-modal causal structure learning for root cause analysis for artificial intelligence operations of a cloud system, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source neurons 612, one or more computation layer(s) 626 having one or more computation neurons 632, and an output layer 640, where there is a single output neuron 642 for each possible category into which the input example could be classified. An input layer 611 can have a number of source neurons 612 equal to the number of data values 612 in the input data 611. The computation neurons 632 in the computation layer(s) 626 can also be referred to as hidden layers, because they are between the source neurons 612 and output neuron(s) 642 and are not directly observed. Each neuron 632, 642 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 626 of the AI model used in the intelligent system manager 340 can incrementally learn the collected data metrics that can likely produce a root cause for system failure code for observations in a sliding window. The output layer 640 of the AI model used in the Intelligent System manager 340 can then provide the overall response of the network as a likelihood score of a root cause for system failure occurring for the processed collected data metric for a given time. In another embodiment, the overall response can be a predicted recommendation to resolve a system issue or vulnerability caused by the flagged root causes for system failure.

Training a deep neural network can involve two phases, a forward phase where the weights of each neuron are fixed and the input propagates through the network, and a backwards phase where an error value is propagated backwards through the network and weight values are updated.

The computation neurons 632 in the one or more computation (hidden) layer(s) 626 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that can perform one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for unsupervised multi-modal causal structure learning for root cause analysis, comprising:
transforming, using a log-tailored language model, system logs of a cloud system to time-series data to obtain system log features of the cloud system;
predicting, using a deep neural network, a metric causal graph and a log causal graph from modality-specific representations and modality-invariant representations of extracted system metric features and system log features, respectively, of the cloud system;
fusing the metric causal graph and log causal graph to obtain a fused causal graph;
flagging root causes of system failure for system maintenance based on ranked entities obtained from the fused causal graph to obtain flagged root causes; and
performing system maintenance autonomously based on the flagged root causes from identified system entities to optimize the cloud system with an updated configuration.

2. The computer-implemented method of claim 1, wherein performing system maintenance autonomously further comprises generating system fix recommendations for the cloud system based on the flagged root causes to assist a decision making of a cloud system professional.

3. The computer-implemented method of claim 1, wherein flagging root causes of system failure for system maintenance further comprises deriving a transition probability matrix based on the fused causal graph to obtain the ranked entities from probability scores of nodes represented by the transition probability matrix.

4. The computer-implemented method of claim 1, wherein predicting, using the deep neural network, the metric causal graph and the log causal graph further comprises maximizing mutual information between the metric causal graph and the log causal graph with contrastive learning regularization to obtain mutual information agreement between modality-invariant representations from both metric and log data.

5. The computer-implemented method of claim 1, wherein predicting, using the deep neural network, the metric causal graph and the log causal graph further comprises performing orthogonal constraint to remove overlaps between the modality-invariant representations and the modality-specific representations.

6. The computer-implemented method of claim 1, wherein predicting, using the deep neural network, the metric causal graph and the log causal graph further comprises performing orthogonal constraint to remove overlaps between the modality-invariant representations and the modality-specific representations.

7. The computer-implemented method of claim 1, wherein fusing, using the deep neural network, the metric causal graph and the log causal graph to obtain a fused causal graph further comprises measuring a cross correlation between a raw feature of an entity for modality representations and key performance indicator (KPI) data.

8. The computer-implemented method of claim 1, wherein fusing, using the deep neural network, the metric causal graph and log causal graph to obtain a fused causal graph further comprises leveraging a modality importance score of the system metric features and the system log features to obtain a fused adjacency matrix for the fused causal graph.

9. A system for unsupervised multi-modal causal structure learning for root cause analysis, comprising:
a memory device; and
one or more processor devices operatively coupled with the memory device to:
transform, using a log-tailored language model, system logs of a cloud system to time-series data to obtain system log features of the cloud system;
predict, using a deep neural network, a metric causal graph and a log causal graph from modality-specific representations and modality-invariant representations of extracted system metric features and system log features, respectively, of the cloud system;
fuse the metric causal graph and log causal graph to obtain a fused causal graph;
flag root causes of system failure for system maintenance based on ranked entities obtained from the fused causal graph to obtain flagged root causes; and
perform system maintenance autonomously based on the flagged root causes from identified system entities to optimize the cloud system with an updated configuration.

10. The system of claim 9, wherein one or more processor devices operatively coupled with the memory device to optimize the cloud system autonomously further comprises further comprises generating system fix recommendations for the cloud system based on the flagged root causes assist a decision making of a cloud system professional.

11. The system of claim 9, wherein one or more processor devices operatively coupled with the memory device to flag root causes of system failure for system maintenance further comprises deriving a transition probability matrix based on the fused causal graph to obtain the ranked entities from probability scores of nodes represented by the transition probability matrix.

12. The system of claim 9, wherein one or more processor devices operatively coupled with the memory device to predict, using the deep neural network, the metric causal graph and the log causal graph further comprises maximizing mutual information between the metric causal graph and the log causal graph with contrastive learning regularization to obtain mutual information agreement between modality-invariant representations from both metric and log data.

13. The system of claim 9, wherein one or more processor devices operatively coupled with the memory device to predict, using the deep neural network, the metric causal graph and the log causal graph further comprises performing orthogonal constraint to remove overlaps between the modality-invariant representations and the modality-specific representations.

14. The system of claim 9, wherein one or more processor devices operatively coupled with the memory device to predict, using the deep neural network, the metric causal graph and the log causal graph further comprises performing orthogonal constraint to remove overlaps between the modality-invariant representations and the modality-specific representations.

15. The system of claim 9, wherein one or more processor devices operatively coupled with the memory device to fuse, using the deep neural network, the metric causal graph and log causal graph to obtain a fused causal graph further comprises measuring a cross correlation between a raw feature of an entity for modality representations and key performance indicator (KPI) data.

16. The system of claim 9, wherein one or more processor devices operatively coupled with the memory device to fuse, using the deep neural network, the metric causal graph and log causal graph to obtain a fused causal graph further comprises leveraging a modality importance score of the system metric features and the system log features to obtain a fused adjacency matrix for the fused causal graph.

17. A non-transitory computer program product comprising a computer-readable storage medium including program code for unsupervised multi-modal causal structure learning for root cause analysis, wherein the program code when executed on a computer causes the computer to:
transform, using a log-tailored language model, system logs of a cloud system to time-series data to obtain system log features of the cloud system;
predict, using a deep neural network, a metric causal graph and a log causal graph from modality-specific representations and modality-invariant representations of extracted system metric features and system log features, respectively, of the cloud system;
fuse the metric causal graph and log causal graph to obtain a fused causal graph by measuring a cross correlation between a raw feature of an entity for modality representations and key performance indicator (KPI) data;
flag root causes of system failure for system maintenance based on ranked entities obtained from the fused causal graph to obtain flagged root causes; and
perform system maintenance autonomously based on the flagged root causes from identified system entities to optimize the cloud system with an updated configuration.

18. The non-transitory computer program product of claim 17, wherein to perform system maintenance autonomously further comprises further comprises to provide system fix recommendations for the cloud system based on the flagged root causes assist a decision making of a cloud system professional.

19. The non-transitory computer program product of claim 17, wherein to flag root causes of system failure for system maintenance further comprises to derive a transition probability matrix based on the fused causal graph to obtain the ranked entities from probability scores of nodes represented by the transition probability matrix.

20. The non-transitory computer program product of claim 17, wherein to predict, using the deep neural network, the metric causal graph and the log causal graph further comprises to maximize mutual information between the metric causal graph and the log causal graph with contrastive learning regularization to obtain mutual information agreement between modality-invariant representations from both metric and log data.
